(19) United States
(12) Patent Application Publication
(10) Pub. No.: US 2026/0326142 A1
(43) Pub. Date: Oct. 22, 2026

(54) LIQUID MATERIAL SUPPLYING APPARATUS FOR GYPSUM PLATE, GYPSUM PLATE MANUFACTURING APPARATUS, AND METHOD OF MANUFACTURING GYPSUM PLATE

(71) Applicant: YOSHINO GYPSUM CO., LTD., Tokyo (JP)

(72) Inventors: Ryota UCHI, Tokyo (JP); Masato HASEGAWA, Tokyo (JP)

(21) Appl. No.: 18/997,903

(22) PCT Filed: Mar. 29, 2023
(86) PCT No.: PCT/JP2023/012899

§ 371 Date: Jan. 23, 2025

(30) Foreign Application Priority Data
Aug. 19, 2022 (JP) 2022-131120

(51) Int. Cl. B05C 11/10; B05C 5/02

(52) U.S. Cl. CPC B05C 11/1015; B05C 5/0245

(57) ABSTRACT

A liquid material supplying apparatus for a gypsum plate is provided for supplying a liquid material to a covering material of a gypsum plate. The liquid material supplying apparatus includes a tank configured to store the liquid material; a liquid material supply pipe that is connected to the tank and is configured to supply the liquid material; a displacement device configured to displace a position of the liquid material supply pipe; an edge detection device configured to detect a position of an edge of the covering material in a width direction; and a controller configured to displace, by the displacement device, the position of the liquid material supply pipe according to the position of the edge of the covering material in the width direction detected by the edge detection device.

### TECHNICAL FIELD

The present invention relates to a liquid material supplying apparatus for a gypsum plate, a gypsum plate manufacturing apparatus, and a method of manufacturing a gypsum plate.

### BACKGROUND OF THE INVENTION

Patent Document 1 discloses a gypsum board having a configuration in which a gypsum core plate is provided between a lower surface sheet and an upper surface sheet.

### RELATED ART DOCUMENTS

### Patent Document

Patent Document 1: Japanese Laid-Open Patent Publication No. H5-148001

### SUMMARY OF THE INVENTION

### Problems to be Solved by the Invention

As a gypsum plate, a gypsum board in which a covering material such as a board base paper, a glass fiber mat, and the like are provided on the surface of a gypsum hardened body is known. The gypsum plate having the covering material is produced by supplying a gypsum slurry between two covering materials and molding or the like.

In the process of producing the gypsum plate having the covering material, the two covering materials are bonded to each other by applying glue to the edges of the two covering materials in the width direction where they overlap. After molding the supplied gypsum slurry, the two bonded covering materials function to support the gypsum slurry in order to maintain the shape near the edge of the gypsum board until the gypsum slurry is sufficiently hardened.

Liquid materials such as lubricants are applied to the edge of the covering material, in addition to the glue.

Incidentally, in a roll in which the covering material is wound that supplies the covering material, the width of the covering material may vary slightly between at the start of the supply and near the end of the supply reaching near the winding bar of the roll.

Therefore, even when the covering material is supplied from the same roll, the position of the edge of the covering material in the width direction may change on the conveyance path of the covering material. Meanwhile, as described above, the glue is required to be applied to the edge of the covering material and the vicinity thereof. In addition, other liquid materials such as the lubricants are also required to be applied to areas at a predetermined distance from the edge. Therefore, when the position of the edge of the covering material in the width direction changes as described above, conventionally, an operator visually checks the position of the edge of the covering material in the width direction, and manually changes and adjusts the position where the liquid material is supplied and applied.

However, depending on the skill of the operator or the like, the liquid material may not be applied at the edge of the covering material in the width direction or at a proper position at a predetermined distance from the edge.

Therefore, for example, when glue is applied as the liquid material, problems such as a decrease in adhesive force between the two covering materials may occur. When the adhesive force between the two covering materials is not sufficient, the strength of the covering material to support the gypsum slurry during the period from molding to hardening of the supplied gypsum slurry is not sufficient, resulting in the occurrence of defective products such that the shape of the edge of the obtained gypsum plate does not meet the standard. Also, when the other liquid materials cannot be applied to a predetermined position, the same causes the occurrence of defective products.

In view of the problems of the conventional technology, it is an object of the present invention to provide a liquid material supplying apparatus for a gypsum plate capable of detecting the position of the edge of the covering material in the width direction and supplying the liquid material.

### Means for Solving the Problem

In order to achieve the above objectives, one aspect of the present invention provides a liquid material supplying apparatus for a gypsum plate for supplying a liquid material to a covering material of a gypsum plate. The liquid material supplying apparatus includes: a tank configured to store the liquid material; a liquid material supply pipe that is connected to the tank and is configured to supply the liquid material; a displacement device configured to displace a position of the liquid material supply pipe; an edge detection device configured to detect a position of an edge of the covering material in a width direction; and a controller configured to displace, by the displacement device, the position of the liquid material supply pipe according to the position of the edge of the covering material in the width direction detected by the edge detection device.

### Effects of the Invention

According to one aspect of the present invention, it is possible to provide a liquid material supplying apparatus for a gypsum plate capable of detecting the position of the edge of the covering material in the width direction and supplying the liquid material.

### BRIEF DESCRIPTION OF THE DRAWINGS

FIG. 1A is a cross-sectional diagram illustrating a gypsum board near the edge in the width direction.

FIG. 1B is a cross-sectional diagram illustrating a gypsum board near the edge in the width direction.

FIG. 1C is a cross-sectional diagram illustrating a gypsum board near the edge in the width direction.

FIG. 2 is an explanatory diagram of a liquid material supplying apparatus for a gypsum plate according to an embodiment of the present invention.

FIG. 3 is a side view around a discharge port of the liquid material supplying apparatus for a gypsum plate.

FIG. 4 is an enlarged top view around an edge detection device.

FIG. 5A is an explanatory diagram of light projection positions from the edge detection device when the edge detection device includes a laser sensor.

FIG. 5B is an explanatory diagram of light projection positions from the edge detection device when the edge detection device includes a laser sensor.

FIG. 5C is an explanatory diagram of light projection positions from the edge detection device when the edge detection device includes a laser sensor.

FIG. 6 is an explanatory diagram of a gypsum plate manufacturing apparatus according to an embodiment of the present invention.

### DETAILED DESCRIPTION OF THE INVENTION

Hereinafter, an embodiment for implementing the present invention will be described with reference to the drawings, but the present invention is not limited to the following embodiments, and various modifications and substitutions can be made to the following embodiments without departing from the scope of the present invention.

### Liquid Material Supplying Apparatus for Gypsum Plate

### (1) Bonding Portion of Covering Material for Gypsum Plate

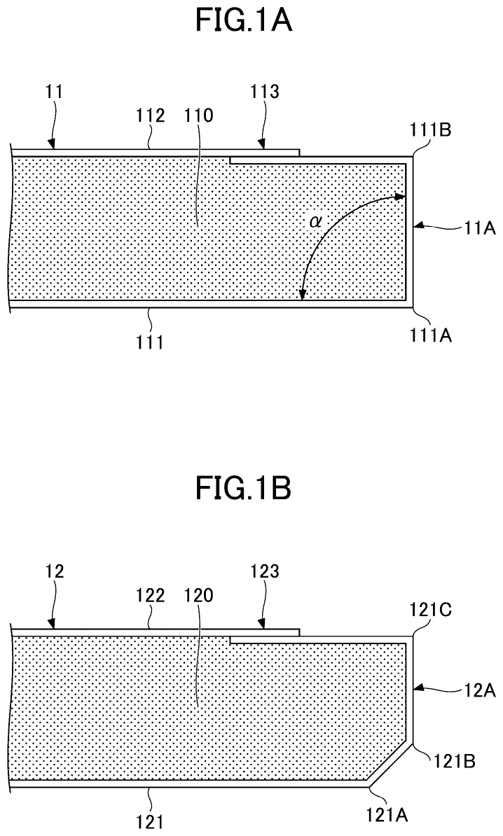

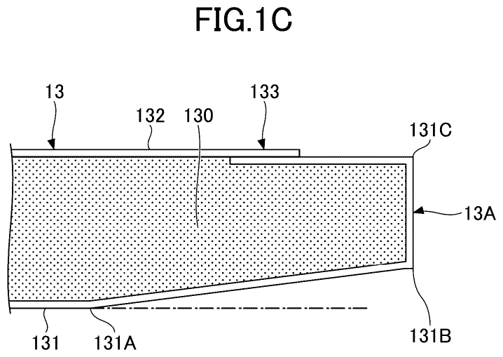

Before describing the liquid material supplying apparatus for a gypsum plate according to the present embodiment, a bonding portion of the covering material will be described with reference to FIGS. 1A to 1C.

FIGS. 1A to 1C are diagrams schematically illustrating a cross section of a gypsum board, which is a kind of a gypsum plate, near the edge in the width direction.

A gypsum board 11 illustrated in FIG. 1A includes a gypsum core 110 made of a hardened body of gypsum slurry, a first board base paper 111, and a second board base paper 112. The gypsum board 11 has a form in which the gypsum core 110 is covered with the first board base paper 111 and the second board base paper 112 as the covering materials.

The gypsum board 11 has an edge 11A in the form of a square edge, and an angle a of each corner is set at a substantially right angle. The first board base paper 111 is bent at corners 111A and 111B to form the edge 11A of the gypsum board 11. Glue is applied to an application area of the surface of the second board base paper 112 facing the first board base paper 111, and the application area is overlapped on the upper surface of the edge of the first board base paper 111 to form a bonding portion 113.

A gypsum board 12 illustrated in FIG. 1B also includes a gypsum core 120 made of a hardened body of gypsum slurry, a first board base paper 121, and a second board base paper 122. The gypsum board 12 has a form in which the gypsum core 120 is covered with the first board base paper 121 and the second board base paper 122 as the covering materials.

The gypsum board 12 has an edge 12A in the form of a beveled edge. The first board base paper 121 is bent at corners 121A, 121B, and 121C to form the edge 12A of the gypsum board 12. Glue is applied to an application area of the surface of the second board base paper 122 facing the first board base paper 121, and the application area is overlapped on the upper surface of the edge of the first board base paper 121 to form a bonding portion 123.

A gypsum board 13 illustrated in FIG. 1C also includes a gypsum core 130 made of a hardened body of gypsum slurry, a first board base paper 131, and a second board base paper 132. The gypsum board 13 has a form in which the gypsum core 130 is covered with the first board base paper 131 and the second board base paper 132 as the covering materials.

The gypsum board 13 has an edge 13A in the form of a tapered edge. The first board base paper 131 is bent at corners 131A, 131B, and 131C to form the edge 13A of the gypsum board 13. Glue is applied to an application area of the surface of the second board base paper 132 facing the first board base paper 131, and the application area is overlapped on the upper surface of the edge of the first board base paper 131 to form a bonding portion 133.

When the liquid material is glue, the liquid material supplying apparatus for a gypsum plate according to the present embodiment is an apparatus for supplying glue to the application areas on the opposing surfaces of two covering materials in order to form a bonding portion between the covering materials, such as the bonding portion between the first board base paper and the second board base paper that are the covering materials.

The liquid material supplied by the liquid material supplying apparatus for a gypsum plate according to the present embodiment is not limited to glue. Examples of the liquid material include various kinds of liquid additives to be supplied to the covering materials, and include one or more materials selected from glue, lubricant, and the like.

The liquid material supplying apparatus for a gypsum plate according to the present embodiment can be used, for example, by providing the liquid material supplying apparatus for a gypsum plate in a line for manufacturing gypsum plates, such as a gypsum plate manufacturing apparatus described later.

The types of the gypsum plate manufactured by applying the liquid material supplying apparatus for a gypsum plate according to the present embodiment are not particularly limited. Various kinds of gypsum plates may be used in which the covering materials are arranged on the surfaces of the gypsum hardened body obtained by hardening gypsum slurry. Examples of the gypsum plate include a gypsum board in which the surfaces of the gypsum plate are covered with the board base papers, and a glass mat gypsum board in which the surfaces of the gypsum plate are covered with glass fiber mats (sheets).

Examples of the covering material to which the liquid material is supplied by the liquid material supplying apparatus for a gypsum plate according to the present embodiment include the board base paper, the glass fiber mat, and the like.

### (2) Liquid Material Supplying Apparatus for Gypsum Plate

An exemplary configuration of the liquid material supplying apparatus for a gypsum plate according to the present embodiment will be described with reference to the drawings.

The liquid material supplying apparatus for a gypsum plate according to the present embodiment (hereinafter, also referred to as “supplying apparatus”) is a liquid material supplying apparatus for a gypsum plate that supplies the liquid material to the covering material of the gypsum plate, and includes a tank, a liquid material supply pipe, a displacement device, an edge detection device, and a controller described below.

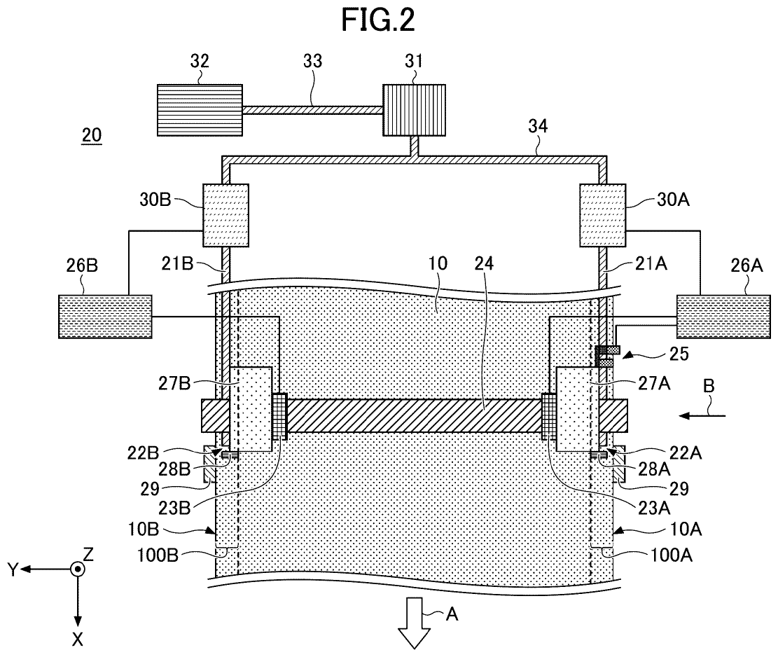

FIG. 2 is a top view of the supplying apparatus 20 according to the present embodiment. FIG. 2 is a schematic diagram illustrating the supplying apparatus 20 according to the present embodiment when the liquid material is supplied to the application areas 100A and 100B near the edges 10A and 10B in the width direction of the covering material 10 being conveyed along a block arrow A.

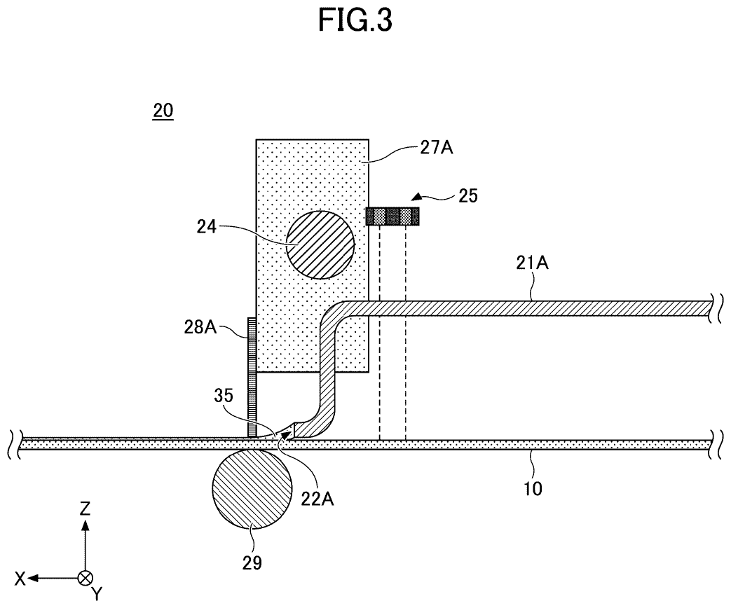

FIG. 3 is a side view around a discharge port 22A of the supplying apparatus 20 according to the present embodiment as seen along an arrow B in FIG. 2.

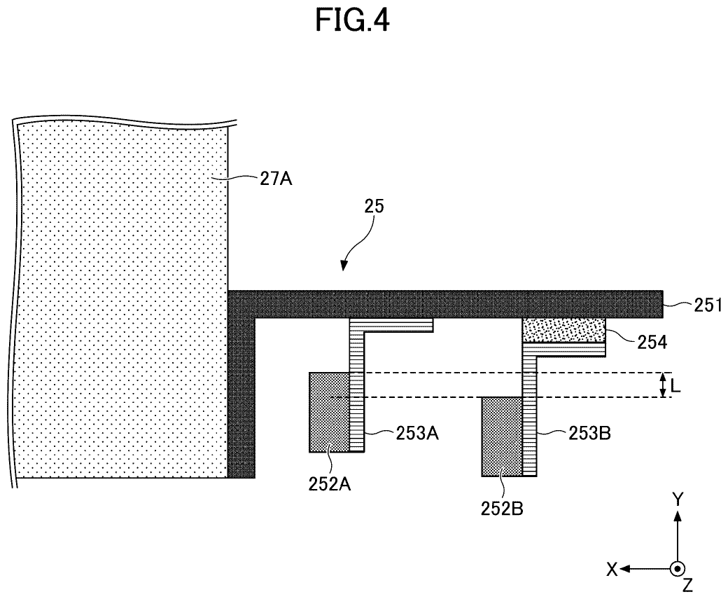

FIG. 4 is an enlarged top view around an edge detection device 25.

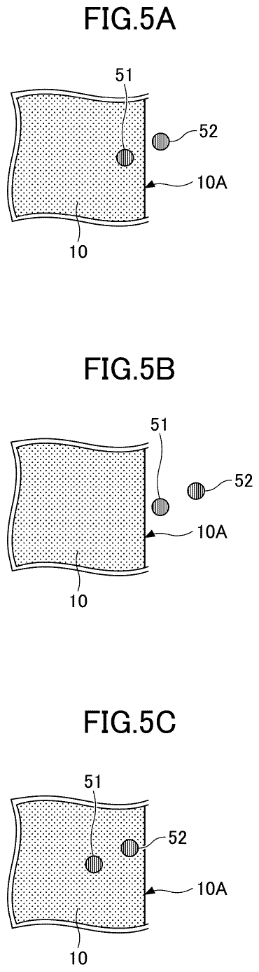

FIGS. 5A to 5C are explanatory diagrams of light projection positions from the edge detection device when the edge detection device includes a laser sensor.

In FIGS. 2 to 4, the X-axis indicates the conveying direction of the covering material, the Y-axis indicates the width direction of the covering material, and the Z-axis indicates the height direction. The drawings are schematically illustrated for explaining the configuration of the supplying apparatus according to the present embodiment, and do not accurately depict the size and the like.

As illustrated in FIG. 2, when a gypsum plate is manufactured, glue, which is a kind of the liquid material, is usually applied to both edges of the covering material 10 in the width direction. For example, a case is described for manufacturing the gypsum board 11 having the square edge in which the gypsum core 110 made of the hardened body of the gypsum slurry is covered with the first board base paper 111 and the second board base paper 112, illustrated in FIG. 1A. In this case, the first board base paper 111 is bent to form the edge 11A of the gypsum board 11. Then, glue is applied to the surface of the second board base paper 112 facing the first board base paper 111, and the application area is overlapped on the upper surface of the edge of the first board base paper 111 to form the bonding portion 113. Therefore, the supplying apparatus 20 according to the present embodiment illustrated in FIG. 2 includes two discharge ports 22A and 22B for supplying the glue according to the number of the application areas 100A and 100B, which are areas to which the glue as the liquid material is applied. However, the configuration is not limited thereto, and the supplying apparatus according to the present embodiment may include, for example, one discharge port. Further, a plurality of supplying apparatuses may be used according to the number of the application areas to which the liquid material is applied, and the like.

In the following, members included in the Supplying apparatus according to the present embodiment will be described below with reference to FIGS. 2, 3, 4, and FIGS. 5A to 5C.

### (2-1) Tank

A tank 31 may store the liquid material to be supplied to the covering material 10.

The tank 31 is connected to first liquid material supply pipes 21A and 21B and a second liquid material supply pipe 34, described later, that are pipes for supplying the liquid material to the discharge ports 22A and 22B, and stores the liquid material to be supplied to the covering material 10. The shape and the like of the tank 31 are not particularly limited as long as the liquid material can be stored. The number of the tanks 31 included in the supplying apparatus 20 is not particularly limited, and the supplying apparatus 20 may include, for example, one tank or a plurality of tanks.

Even when the supplying apparatus 20 according to the present embodiment includes a plurality of discharge ports 22A and 22B and a plurality of pumps 30A and 30B, the supplying apparatus 20 may include the one tank 31, and the liquid material supply pipe for supplying the liquid material from the tank 31 to the discharge ports 22A and 22B may be branched, as illustrated in FIG. 2, for example. The supplying apparatus 20 according to the present embodiment may include a plurality of, for example, two tanks 31 according to the number of the discharge ports 22A and 22B and the pumps 30A and 30B.

The tank 31 may be a temporary buffer tank, that is, a tank that functions as an auxiliary tank. When the tank 31 is a buffer tank, one or more main tanks 32 may be provided on the upstream side of a liquid material supply path relative to the tank 31, and the main tank 32 and the tank 31 may be connected by a third liquid material supply pipe 33. A pump for conveying the liquid material from the main tank 32 to the tank 31 may be provided on the liquid material supply path of the third liquid material supply pipe 33 as necessary. The type of the pump is not particularly limited as long as the liquid material can be conveyed to the tank 31. When a plurality of main tanks 32 are provided, a valve for switching the main tanks 32 to be connected to the tank 31 may be provided between the main tanks 32 and the tank 31.

The main tanks 32 are not necessarily provided, and tank 31 alone may be provided for storing the liquid material.

### (2-2) Liquid Material Supply Pipe and Discharge Port

The liquid material supply pipe is a pipe connected to the tank 31 and is configured to supply the liquid material.

The discharge ports 22A and 22B are provided at the ends of the liquid material supply pipe, and are configured to discharge the liquid material from the ends of the liquid material supply pipe onto the covering material 10.

### (Discharge Port)

The discharge ports 22A and 22B, which are the ends of the liquid material supply pipe, are preferably provided so as to supply the liquid material to, for example, the vicinity of the edges of the covering material 10 in the width direction, specifically, to the application areas 100A and 100B. The positions of the application areas 100A and 100B are not limited to the configuration illustrated in FIG. 2 as will be described later, and can be selected according to the type of the liquid material, the manufacturing conditions of the gypsum plate, and the like. The number of the discharge ports 22A and 22B included in the supplying apparatus 20 according to the present embodiment is not particularly limited, and the supplying apparatus 20 may include one discharge port or a plurality of discharge ports.

For example, the supplying apparatus 20 according to the present embodiment may include two discharge ports 22A and 22B according to the number of the application areas 100A and 100B to which the liquid material is applied, as in the supplying apparatus 20 illustrated in FIG. 2.

As illustrated in FIG. 2, when the supplying apparatus 20 according to the present embodiment includes two discharge ports 22A and 22B, the discharge ports 22A and 22B may be provided so as to supply the liquid material to the application areas 100A and 100B provided near the edges 10A and 10B of the covering material 10, for example. That is, the liquid material supply pipes may be provided at both edges 10A and 10B of the covering material 10 in the width direction. Specifically, the first liquid material supply pipes 21A and 21B and the discharge ports 22A and 22B as the ends thereof may be provided at both edges 10A and 10B of the covering material 10 in the width direction, respectively. Thus, by providing the first liquid material supply pipes 21A and 21B and the discharge ports 22A and 22B as the ends thereof at both edges of the covering material 10 in the width direction, the liquid material can be applied to both edges of the covering material 10 in the width direction at the same time.

The width, position, and number of the application areas 100A and 100B are not particularly limited because they are selected according to the manufacturing conditions of the gypsum plate such as the type of the liquid material. When the liquid material is glue, it is usually required to apply glue to the bonding portion of the covering material 10, and therefore, as illustrated in FIG. 2, for example, the application areas 100A and 100B may be provided on the back surface of the covering material 10 including the edges 10A and 10B, respectively. When the liquid material is glue, the width of the application areas 100A and 100B may be selected in accordance with the width of the overlap with the other covering material to be bonded.

As described above, the width, position, and number of the application areas 100A and 100B are selected according to the type of the liquid material, the manufacturing conditions of the gypsum plate, and the like, and therefore, the positions of the application areas 100A and 100B and the like are not limited to the examples described above. For example, the application areas may be provided on the front surface of the covering material 10 instead of or in addition to the back surface of the covering material 10.

The discharge ports 22A and 22B may be provided so as to supply the liquid material 35 to the application area of the covering material 10, for example, as illustrated in FIG. 3. The discharge ports 22A and 22B may be provided such that they face the covering material 10, or that, as illustrated in FIG. 3, the discharge direction of the liquid material from the discharge port 22A is set along the conveying direction of the covering material 10. The shape of the discharge ports 22A and 22B is not particularly limited, but may be circular, or may be elliptical, polygonal, or the like according to the shape of the application area.

The discharge ports 22A and 22B may be provided, for example, at the ends of the first liquid material supply pipes 21A and 21B, which are connected to the pumps 30A and 30B and are the liquid material supply pipes for supplying the liquid material, on the side opposite to the side connected to the pumps 30A and 30B.

### (Liquid Material Supply Pipe)

The supplying apparatus 20 according to the present embodiment may include the first liquid material supply pipes 21A and 21B, and the second liquid material supply pipe 34, which are liquid material supply pipes connected to the tank 31 and are configured to supply the liquid material.

The pumps 30A and 30B, which will be described later, may be provided between each of the first liquid material supply pipes 21A and 21B and the second liquid material supply pipe 34.

The supplying apparatus 20 according to the present embodiment may include liquid material supply pipes between the respective members in order to constitute a conveyance path of the liquid material in the apparatus. In the present specification, in order to clarify which part of the liquid material supply pipe is referred to, for the sake of convenience, the names of the liquid material supply pipes may be described separately, such as the first liquid material supply pipes 21A and 21B, the second liquid material supply pipe 34, and the third liquid material supply pipe 33, as described above.

The materials and the like of the first liquid material supply pipes 21A and 21B and the second liquid material supply pipe 34 are not particularly limited, but it is preferable that at least the inner surfaces of the first liquid material supply pipes 21A and 21B and the second liquid material supply pipe 34 are made of silicone resin. Further, it is more preferable that the first liquid material supply pipes 21A and 21B and the second liquid material supply pipe 34 are hoses made of silicone resin.

When the supplying apparatus 20 is used for a long period of time, the liquid material may be solidified and may develop into a lump, and as a result, residues may be generated. When such residues are produced in the liquid material supply pipe, the supply of the liquid material would be blocked or the residues in a lump would be discharged onto the covering material 10, thereby resulting in a defective product. To address this, by making the inner surfaces of the first liquid material supply pipes 21A and 21B and the second liquid material supply pipe 34 made of silicone resin, even when the liquid material is partially solidified, the solidified liquid material can be discharged before developing into a large lump. Accordingly, it is possible to prevent the supply of the liquid material from being blocked and or prevent residues in a lump from being discharged onto the covering material 10.

For the same reason, with respect to the other liquid material supply pipes such as the third liquid material supply pipe 33, which connect the members and are in contact with the liquid material, it is preferable that at least the inner surfaces thereof are made of silicone resin, and it is more preferable that they are hoses made of silicone resin.

### (2-3) Edge Detection Device

The edge detection device 25 can detect the position of the edge 10A of the covering material 10 in the width direction.

As described above, in a roll in which the covering material is wound that supplies the covering material, the width of the covering material may vary slightly between at the start of the supply and near the end of the supply reaching near the winding bar of the roll. Therefore, even when the covering material is supplied from the same roll, the position of the edge of the covering material in the width direction may change on the conveyance path of the covering material. Meanwhile, the liquid material is applied to the application area at a predetermined distance from the edge of the covering material, the area being set according to the manufacturing conditions of the gypsum plate, such as the edge of the covering material and the vicinity thereof. Therefore, when the position of the edge of the covering material in the width direction changes, conventionally, an operator visually checks the position of the edge of the covering material in the width direction, and manually changes and adjusts the position where the liquid material is supplied and applied.

However, there is a problem that, depending on the skill of the operator or the like, the liquid material may not be applied to a proper position of the edge of the covering material in the width direction.

Therefore, the supplying apparatus 20 according to the present embodiment may include the edge detection device 25 that can detect the position of the edge 10A of the covering material 10 in the width direction.

By including the edge detection device 25, the position of the edge 10A of the covering material 10 in the width direction can be detected, and the positions of the first liquid material supply pipe 21A and the discharge port 22A can be displaced based on the detected data. Therefore, the liquid material can be supplied and applied from the discharge port 22A to a proper position on the covering material 10.

The configuration of the edge detection device 25 is not particularly limited, but may be constituted by, for example, an imaging apparatus and an image analysis apparatus, and may be configured to detect the position of the edge 10A by analyzing an image of the covering material 10 being conveyed. The edge detection device 25 may be configured to detect the position of the edge 10A of the covering material 10 in the width direction by various sensors.

In particular, it is preferable that the edge detection device 25 is provided with a laser sensor because of the short time required for detection, relatively low cost, and excellent detection accuracy.

The laser sensor is a sensor that uses a laser as a light emitting element. The laser sensor projects a laser beam onto an object to be detected, and then detects the presence or absence of the object to be detected at the light projection position and the state thereof by using the change in the amount of light transmitted through or reflected from the object to be detected and subsequently incident on the light receiver.

For example, as illustrated in FIG. 4, the edge detection device 25 may include a first laser sensor 252A and a second laser sensor 252B arranged along the width direction (Y-axis) of the covering material.

The first laser sensor 252A and the second laser sensor 252B illustrated in FIG. 4 are arranged along the width direction of the covering material 10 separated by a distance I as described later. In FIG. 4, the first laser sensor 252A is arranged closer to the center of the covering material 10 in the width direction than the second laser sensor 252B.

When the laser sensor is arranged along the width direction of the covering material 10 as described above, the edge of the covering material in the width direction can be detected as follows.

As illustrated in FIG. 5A, suppose that it is detected that the covering material 10 is arranged at a light projection position 51 of the first laser sensor 252A and that the covering material 10 is not arranged at a light projection position 52 of the second laser sensor 252B. In this case, the edge 10A of the covering material 10 is positioned between the light projection positions 51 and 52, and the position of the edge 10A can be detected.

As illustrated in FIG. 5B, suppose that it is detected that the covering material 10 is not arranged at both the light projection position 51 of the first laser sensor 252A and the light projection position 52 of the second laser sensor 252B. In this case, the edge 10A of the covering material 10 is positioned closer to the center of the covering material 10 in the width direction than the light projection positions 51 and 52.

As illustrated in FIG. 5C, suppose that it is detected that the covering material 10 is arranged at both the light projection position 51 of the first laser sensor 252A and the light projection position 52 of the second laser sensor 252B. In this case, the edge 10A of the covering material 10 is positioned further away from the center of the covering material 10 in the width direction than the light projection positions 51 and 52.

Therefore, when the covering material 10 is positioned at the light projection position 51 of the first laser sensor 252A and the covering material 10 is not positioned at the light projection position 52 of the second laser sensor 252B, it can be detected that the edge 10A of the covering material 10 is positioned between the light projection positions 51 and 52. Specifically, in the above case, it can be detected that the edge 10A of the covering material 10 is positioned between the light projection position 51 of the first laser sensor 252A and the light projection position 52 of the second laser sensor 252B.

When the positional relationship between the edge 10A of the covering material 10 and the light projection positions 51 and 52 is as illustrated in FIGS. 5B and 5C, the position of the edge detection device 25 is changed by a displacement device or the like described later, and the operation of detecting the edge again can be repeatedly performed until the relationship between the edge of the covering material and the light projection positions is as illustrated in FIG. 5A. When the light projection positions 51 and 52 have the positional relationship illustrated in FIG. 5A, the position of the edge 10A of the covering material 10 can be accurately detected.

The first laser sensor 252A and the second laser sensor 252B can be arranged apart along the width direction of the covering material 10 as described above. The distance L between the first laser sensor 252A and the second laser sensor 252B along the width direction of the covering material 10 is not particularly limited. The distance L is preferably 0.1 mm or more and 5 mm or less, more preferably 0.1 mm or more and 1 mm or less, and more preferably 0.1 mm or more and 0.5 mm or less. By setting the distance L to 5 mm or less, the distance between the light projection positions 51 and 52 from the first laser sensor 252A and the second laser sensor 252B can be shortened. Therefore, the detection accuracy of the edge 10A of the covering material 10 can be improved.

By setting the distance L to 0.1 mm or more, interference between the laser light from the first laser sensor 252A and the laser light from the second laser sensor 252B can be prevented. Therefore, deterioration in measurement accuracy due to the interference can also be suppressed.

For example, as illustrated in FIG. 4, the first laser sensor 252A and the second laser sensor 252B may be fixed to the fixing base 251 via L-shaped fittings 253A and 253B with bolts or the like (not illustrated). The distance L may be adjusted, for example, when fixing the second laser sensor 252B and the fixing base 251 via the L-shaped fitting 253B, by providing a shim plate 254 as a spacer between the fixing base 251 and the L-shaped fitting 253B. Specifically, by making the thickness of the shim plate 254 the same as the desired distance L, the distance between the first laser sensor 252A and the second laser sensor 252B of the covering material 10 in the width direction can be the distance L.

In FIG. 4, the first laser sensor 252A and the second laser sensor 252B are arranged apart from each other along the conveying direction (X-axis) of the covering material due to the configuration of the apparatus.

The edge detection device 25 may be provided at a position required to detect an edge of the covering material 10 in the width direction, and the number of the edge detection devices 25 included in the supplying apparatus 20 is not particularly limited.

For example, when the supplying apparatus 20 includes two discharge ports 22A and 22B, two edge detection devices 25 may be provided according to the number of the discharge ports. Further, for example, when it is controlled to supply the covering material 10 such that the supply position of one edge 10B of the edges 10A and 10B of the covering material 10 in the width direction is kept constant, that is, when the position of the edge 10B does not need to be detected, the edge detection device 25 may be provided only on the side of the discharge port 22A, as illustrated in FIG. 2. That is, the edge detection device 25 may detect the position of one edge 10A of the covering material 10 in the width direction. In this case, the displacement device described later displaces the position of the first liquid material supply pipe 21A provided on one edge 10A of the covering material 10 in the width direction, or displaces the position of the discharge port 22A, which is the end of the first liquid material supply pipe 21A.

By configuring the edge detection device 25 to detect only the position of one edge 10A of the covering material 10 in the width direction, the control during the supply of the liquid material can be further simplified, and the cost of the supplying apparatus 20 can be reduced.

### (2-4) Displacement Device

The displacement device may displace the position of the first liquid material supply pipes 21A and 21B, and the discharge ports 22A and 22B, which are the ends of the first liquid material supply pipes 21A and 21B, along the width direction of the covering material 10.

As described above, when the edge detection device 25 detects the position of the edge 10A of the covering material 10 in the width direction, the position of the edge detection device 25 may be moved along the width direction of the covering material 10. Thus, it is preferable that the displacement device also moves the edge detection device 25 together with the first liquid material supply pipes 21A and 21B and the discharge ports 22A and 22B, which are the ends of the first liquid material supply pipes 21A and 21B.

The configuration of the displacement device is not particularly limited as long as the position of the first liquid material supply pipes 21A and 21B can be displaced along the width direction of the covering material 10.

For example, as illustrated in FIG. 2, the displacement device may include a linear motion mechanism 24 and drive devices 23A and 23B. Examples of the linear motion mechanism 24 include a linear rail (linear guide), a linear shaft, and the like.

Examples of the drive devices 23A and 23B include a linear bush, a linear motor, a motor, and the like.

### (2-5) Controller

The controller 26A may displace, by the displacement device, the position of the first liquid material supply pipe 21A and the discharge port 22A, which is the end of the first liquid material supply pipe 21A, in accordance with the position of the edge 10A of the covering material 10 in the width direction detected by the edge detection device 25.

As described above, when the covering material 10 is positioned at the light projection position of the first laser sensor 252A of the edge detection device 25 and the covering material 10 is not positioned at the light projection position of the second laser sensor 252B, the edge 10A of the covering material 10 is positioned between the two light projection positions. Therefore, the position of the edge 10A of the covering material 10 in the width direction can be detected.

In this case, the controller 26A may displace, by the displacement device, the position of the first liquid material supply pipe 21A and the discharge port 22A, which is the end of the first liquid material supply pipe 21A, in accordance with the detected position of the edge 10A of the covering material 10 in the width direction.

The controller 26A may displace, by the displacement device, the position of the edge detection device 25 in order for the edge detection device 25 to detect the position of the edge 10A of the covering material 10 in the width direction.

As will be described later, the supplying apparatus 20 according to the present embodiment may also include supports 27A and 27B to which the first liquid material supply pipes 21A and 21B, the discharge ports 22A and 22B, which are the ends of the first liquid material supply pipes 21A and 21B, and the edge detection device 25 are fixed. In this case, as described above, when the displacement device displaces the position of the edge detection device 25 in order for the edge detection device 25 to detect the edge 10A of the covering material 10 in the width direction, the positions of the first liquid material supply pipe 21A and the discharge port 22A are also displaced via the support 27A.

Because an example in which the edge detection device 25 is provided only on the side of one edge 10A of the covering material 10 in the supplying apparatus 20 is illustrated in FIG. 2, only the controller 26A has been described above, but the configuration is not limited thereto. The edge detection device 25 may also be provided on the side of the other edge 10B of the covering material 10 and controlled by the controller 26B in the same manner as in the case of the controller 26A.

The controllers 26A and 26B may include a CPU serving as an arithmetic processing unit for performing calculations necessary for control, a RAM or ROM serving as a main memory, an auxiliary memory, an input/output interface, and a display serving as an output device. The CPU, the main memory, the auxiliary memory, the input/output interface, and the output device of the controllers 26A and 26B may be connected to each other by a bus. It is not necessary that all of the above-mentioned members of the controllers 26A and 26B are housed in the same housing, and for example, the auxiliary memory and the display may be provided externally. The auxiliary memory is a storage device such as an SSD or HDD.

Note that the CPU stands for a central processing unit, the RAM stands for a random access memory, and the ROM stands for a read only memory. The SSD stands for a solid state drive, and the HDD stands for a hard disk drive.

Examples of the input/output interface include wired or wireless interfaces for exchanging detection data obtained by the edge detection device 25, a control amount at the displacement device, and the like. The controllers 26A and 26B may also be configured to exchange data with the tank 31 and the pumps 30A and 30B as necessary. The controllers 26A and 26B may be configured to acquire, for example, data on the amount of liquid material remaining in the tank 31, data on temperature and the like, data on the operating conditions of the pumps 30A and 30B, and the like. In this case, the controllers 26A and 26B may use data from the tank 31 and the pumps 30A and 30B when determining the control conditions.

The input/output interface may also include a user interface such as a touch panel, keyboard, and operation buttons for selecting the control conditions.

The controllers 26A and 26B may be configured by a personal computer (PC) or the like. Therefore, in an information processing apparatus such as a personal computer, the above-mentioned components of the controllers 26A and 26B may be implemented in cooperation with software and hardware by executing a program stored in advance by a CPU.

FIG. 2 illustrates an example in which the controllers 26A and 26B are provided in the device arranged at the edge 10A of the covering material 10 and in the device arranged at the edge 10B, but the configuration is not limited thereto. For example, the supplying apparatus 20 may be configured to include only one controller and to control each device by the controller.

The controllers 26A and 26B may also perform control other than the above. For example, they can also control the operation of the pumps 30A and 30B. More specifically, the controllers 26A and 26B may also control the supply rate of the liquid material from the tank 31 to the discharge ports 22A and 22B by the pumps 30A and 30B, and the stop and start of the supply of the liquid material. The supply rate of the liquid material means the supply amount of the liquid material per unit time.

The controllers 26A and 26B may control the supply rate of the liquid material according to, for example, the conveyance speed of the covering material 10 for supplying the liquid material. The conveyance speed of the covering material 10 is selected in accordance with the manufacturing conditions of the gypsum plate using the covering material and constitutes the manufacturing conditions of the gypsum plate. Therefore, the controllers 26A and 26B may control the supply rate of the liquid material from the tank 31 to the discharge ports 22A and 22B by the pumps 30A and 30B in accordance with the manufacturing conditions of the gypsum plate manufactured by, for example, the gypsum plate manufacturing apparatus and the like to which the supplying apparatus 20 is provided.

By controlling, by the controllers 26A and 26B, the supply rate of the liquid material from the tank 31 to the discharge ports 22A and 22B by the pumps 30A and 30B in accordance with the manufacturing conditions of the gypsum plate to be manufactured, the liquid material can be supplied onto the covering material under the optimum conditions in accordance with the manufacturing conditions of the gypsum plate to be manufactured.

### (2-7) Pump

The pumps 30A and 30B may be provided on the liquid material supply paths between the tank 31 and the discharge ports 22A and 22B. In order to accurately adjust the discharge of the liquid material from the discharge ports 22A and 22B, the pumps 30A and 30B are preferably provided for each of the discharge ports 22A and 22B. When two pumps 30A and 30B and two discharge ports 22A and 22B are provided as illustrated in FIG. 2, two pumps 30A and 30B are preferably arranged in parallel on the liquid material supply paths between the tank 31 and the discharge ports 22A and 22B.

In the case of the supplying apparatus 20 illustrated in FIG. 2, the liquid material supply paths between the tank 31 and the discharge ports 22A and 22B are composed of the second liquid material supply pipe 34 and the first liquid material supply pipes 21A and 21B.

The types of pumps used for the pumps 30A and 30B are not particularly limited, but for example, a positive displacement pump may be used.

The positive displacement pump is a pump that changes the volume of a fluid substance such as glue in a fixed space volume by reciprocating motion or rotary motion, gives energy to the fluid substance, and conveys the fluid substance.

The positive displacement pump can supply a fixed amount of a fluid substance such as glue at a constant rate. The positive displacement pump can be broadly classified into a rotary positive displacement pump and a reciprocating positive displacement pump. By controlling the conditions of the rotary motion or reciprocating motion, the supply amount can be readily and accurately controlled.

Therefore, by using the positive displacement pump as the pumps 30A and 30B, a proper amount of the liquid material can be stably supplied to the covering material. As a result, when the liquid material is glue, the covering materials can be stably bonded, and the edge shape of the gypsum plate can be formed into a desired shape. In addition, the occurrence of defective products can be reduced, due to the shape of the edge of the gypsum plate not meeting the standard and the like when the gypsum plate is manufactured. Further, when the liquid material is glue, a situation in which glue leaking from the covering material 10 is solidified and adheres to a molding machine can be minimized, and formation of dents and the like on the surface of the gypsum plate due to the solidified glue can be reduced.

The positive displacement pump can be roughly divided into a rotary positive displacement pump (rotary pump) and a reciprocating positive displacement pump (reciprocating pump). The rotary positive displacement pump is a positive displacement pump that sucks and discharges a fluid substance by rotary motion of a rotating component. Examples of the rotary positive displacement pump include a gear pump, a vane pump, a screw pump, and the like. The reciprocating positive displacement pump is a positive displacement pump that sucks and discharges a fluid substance by reciprocating motion of a component. Examples of the reciprocating positive displacement pump include a piston pump, a plunger pump, a diaphragm pump, and the like. The positive displacement pump used as the pumps 30A and 30B of the supplying apparatus 20 according to the present embodiment may be either the rotary positive displacement pump or the reciprocating positive displacement pump.

The positive displacement pump used as the pumps 30A and 30B is more preferably a screw pump. The screw pump is a type of a pump that conveys an object using a screw rotor.

In the screw pump, the screw rotor rotates in a stator such that a series of independent sealed spaces called cavities are formed in a gap between the rotor and the stator. Then, by the rotor rotating in the stator, the cavities move toward the discharge side while generating a strong suction force such that the liquid material can be conveyed.

According to the screw pump, because a constant conveyance quantity can be achieved without pulsation, the supply amount of the liquid material can be particularly accurately controlled, and the screw pump can be used more preferably as the positive displacement pump as described above.

Among the screw pumps, a uniaxial screw pump may be particularly preferably used. As the uniaxial screw pump, for example, a uniaxial eccentric screw pump (a MONO pump (registered trademark), which may also be called a MOYNO pump) is known and may be preferably used.

The pump 30A and the pump 30B may be different types of pumps. However, the pump 30A and the pump 30B are preferably of the same type of pumps because it is preferable for the liquid material to be supplied to each of the application areas 100A and 100B of the covering material 10 at the same supply rate.

The pumps 30A and 30B may be connected to the tank 31 by the second liquid material supply pipe 34. In FIG. 2, the second liquid material supply pipe 34 branches at its midsection. However, respective second liquid material supply pipes 34 may be provided for the pumps 30A and 30B, and the pumps 30A and 30B may be directly connected to the tank 31.

### (2-8) Support

The supplying apparatus 20 according to the present embodiment may also include the supports 27A and 27B.

To the supports 27A and 27B, the first liquid material supply pipes 21A and 21B and the edge detection device 25 are fixed.

The shapes of the supports 27A and 27B are not particularly limited. Preferably, the supports 27A and 27B are configured to be able to fix the first liquid material supply pipes 21A and 21B, the discharge ports 22A and 22B, which are the ends of the first liquid material supply pipes 21A and 21B, and the edge detection device 25. Preferably, the supports 27A and 27B are configured to be able to displace the first liquid material supply pipes 21A and 21B, the discharge ports 22A and 22B, which are the ends of the first liquid material supply pipes 21A and 21B, and the edge detection device 25, together with the displacement of the supports 27A and 27B.

As illustrated in FIGS. 2 and 3, the supports 27A and 27B are preferably connected to the displacement device. In this case, the displacement device can collectively displace the positions of the first liquid material supply pipes 21A and 21B, the discharge ports 22A and 22B, which are the ends of the first liquid material supply pipes 21A and 21B, and the edge detection device 25, by displacing the positions of the supports 27A and 27B along the width direction of the covering material 10.

For example, the controller 26A preferably displaces the position of the support 27A by the displacement device such that the covering material 10 is positioned at the light projection position of the first laser sensor 252A and the covering material 10 is not positioned at the light projection position of the second laser sensor 252B.

In this case, it is preferable to fix the edge detection device 25, the first liquid material supply pipe 21A, and the discharge port 22A to the support 27A so that the discharge port 22A can supply the liquid material to the application area 100A when the edge detection device 25 is positioned at a position corresponding to the edge 10A of the covering material 10 in the width direction, that is, at a position where the edge 10A is detected.

As described above, because an example in which the edge detection device 25 is provided only on the side of one edge 10A of the covering material 10 in the supplying apparatus 20 is illustrated in FIG. 2, only the controller 26A has been described above, but the configuration is not limited thereto. The edge detection device 25 may also be provided on the side of the other edge 10B of the covering material 10 and controlled by the controller 26B in the same manner as in the case of the controller 26A.

### (2-9) Spreading Member

The supplying apparatus 20 may further include spreading members 28A and 28B configured to spread the liquid material 35 supplied from the discharge ports 22A and 22B onto the covering material 10.

As illustrated in FIG. 3, the spreading members 28A and 28B may spread the liquid material 35 supplied from the discharge ports 22A and 22B onto the application areas 100A and 100B of the covering material 10 over the entire predetermined range of the application areas 100A and 100B while suppressing variations in thickness.

Each of the spreading members 28A and 28B may be any member that can spread the liquid material 35. For example, a spatula, a roller, a brush, or the like may be used. In particular, the spatula may be particularly preferably used.

When the spatula is used as the spreading members 28A and 28B, any shape and number of notches may be provided on the sides of the spreading members 28A and 28B facing the covering material 10 to adjust the shape or the like of the application of the liquid material 35.

In the case where the spreading members 28A and 28B are provided, it is preferable to provide support members, for example, rollers 29, on the opposite side of the covering material 10 from the spreading members 28A and 28B.

By providing the rollers 29, the load and the like of the spreading members 28A and 28B and the covering material 10 can be supported. The spreading members 28A and 28B are supported by the rollers 29 via the covering material 10.

Therefore, by providing the rollers 29, when the liquid material 35 is pressed against the covering material 10 and spread by the spreading members 28A and 28B, the force applied by the spreading members 28A and 28B can be prevented from escaping. Further, by providing the rollers 29, when the liquid material 35 is pressed against the covering material 10 and spread by the spreading members 28A and 28B, the covering material 10 can be prevented from being damaged or the like.

### Gypsum Plate Manufacturing Apparatus

Next, an exemplary configuration of the gypsum plate manufacturing apparatus according to the present embodiment will be described.

The gypsum plate manufacturing apparatus according to the present embodiment may include the supplying apparatus described above.

The gypsum plate manufacturing apparatus according to the present embodiment may include various means necessary for manufacturing the gypsum plate in addition to the supplying apparatus described above.

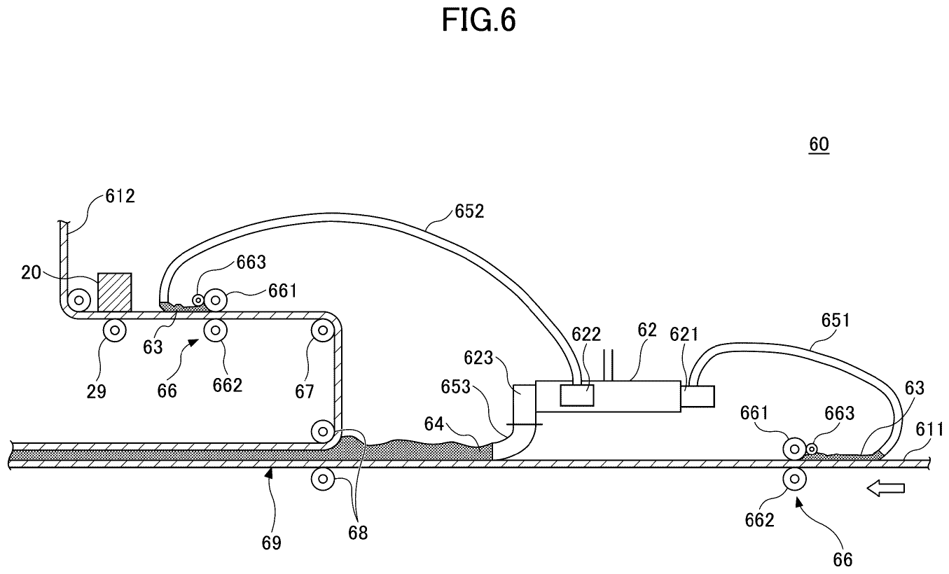

An exemplary configuration of a gypsum plate manufacturing apparatus 60 according to the present embodiment will be described with reference to FIG. 6. The gypsum plate manufacturing apparatus 60 includes, in addition to the supplying apparatus 20 described above, a mixer 62 that is a mixing unit configured to mix raw materials, and a molding machine 68 configured to mold a gypsum slurry prepared by the mixer 62. The exemplary configuration of the gypsum plate manufacturing apparatus will be specifically described below. In the following, a case where the gypsum plate is a gypsum board will be described as an example.

### (1) Mixer

The mixer 62 may be provided at a predetermined position with respect to the conveyance line of a first board base paper 611, a second board base paper 612, and the like that are the covering materials. For example, the mixer 62 may be provided above or alongside the conveyance line. In the single mixer 62, a gypsum slurry may be prepared by kneading calcined gypsum, water, and, in some cases, various additives, which are raw materials of the gypsum slurry.

The calcined gypsum is also called calcium sulfate hemihydrate, and is an inorganic composition having a hydraulic property. As the calcined gypsum, β-calcined gypsum or α-calcined gypsum may be used alone, or a mixture of β-calcined gypsum or α-calcined gypsum may be used. The β-calcined gypsum is obtained by calcining one of or a mixture of natural gypsum, by-product gypsum, flue-gas desulfurization gypsum, recycled gypsum of a waste gypsum plate, and the like in the atmosphere. The α-calcined gypsum is obtained by calcining one of or a mixture of natural gypsum, by-product gypsum, flue-gas desulfurization gypsum, recycled gypsum of a waste gypsum plate, and the like in water (including in steam).

When the gypsum plate is manufactured, the calcined gypsum used as the raw material preferably includes the β-calcined gypsum, and more preferably, the main component of the calcined gypsum used as the raw material of the gypsum plate is the β-calcined gypsum. As used herein, “the main component of the calcined gypsum used as the raw material of the gypsum plate is the β-calcined gypsum” means that the mass percentage of the β-calcined gypsum in the calcined gypsum used as the raw material of the gypsum plate is more than 50%. When the gypsum plate is manufactured, the calcined gypsum used as the raw material may be composed solely of the β-calcined gypsum.

In order to manufacture the α-calcined gypsum, it is necessary to pressure-calcine gypsum dihydrate such as natural gypsum in water or steam by using an autoclave. Conversely, the β-calcined gypsum may be manufactured by calcining gypsum dihydrate such as natural gypsum under normal pressure in the atmosphere. Thus, the β-calcined gypsum may be manufactured at higher productivity as compared to the α-calcined gypsum.

As the additives, for example, one or more of the following may be used: an adhesion improver such as starch and polyvinyl alcohol for improving the adhesion between a hardened gypsum body (a hardened gypsum slurry) and a board base paper; an inorganic fiber such as glass fiber; a lightweight aggregate; a refractory material such as vermiculite; a setting retarder; a setting accelerator; a water reducing agent; a foaming agent such as a sodium alkyl sulfate, alkyl ether sulfate, sodium alkylbenzene sulfonate, and polyoxyethylene alkyl sulfate; a foam size adjusting agent such as a sulfosuccinate surfactant; a water repellent such as silicone or paraffin; an organic carboxylic acid; an organic carboxylate; and the like.

The calcined gypsum and some additives such as, for example, solid additives may be mixed and agitated in advance, and a resulting gypsum composition, which is a mixture, may be supplied to the mixer 62.

Further, foam may be added from one or more of gypsum slurry dispensing ports 621, 622, and 623, and a gypsum slurry with any density may be obtained by adjusting the amount of foam added. For example, a high-density first gypsum slurry 63 may be prepared by not adding foam or by adding a small amount of foam from each of the dispensing port 621 and 622. Further, a low-density second gypsum slurry 64 may be prepared by adding, from the dispensing port 623, an amount of foam greater than the amount of foam added to the first gypsum slurry 63.

Then, the obtained first gypsum slurry 63 is supplied through delivery pipes 651 and 652 to the first board base paper 611 and the second board base paper 612 at positions upstream of roller coaters 66 in the conveying direction of the board base paper.

The high-density first gypsum slurry 63, supplied to the first board base paper 611 and the second board base paper 612, reaches spreading sections of the roller coaters 66 and is spread at the spreading sections. Each of the roller coaters 66 can include a coating roller 661, a receiving roller 662, and a residue removal roller 663. When the first board base paper 611 or the second board base paper 612 pass between the coating roller 661 and the receiving roller 662, the first gypsum slurry 63 can be spread on the first board base paper 611 or the second board base paper 612.

In this manner, a thin layer of the first gypsum slurry 63 is formed on the first board base paper 611. Then, the first board base paper 611 is folded such that its side edges extend upward and then extend inward. A thin layer of the first gypsum slurry 63 is also formed on the second board base paper 612. However, unlike the first board base paper 611, the second board base paper 612 is not folded. Note that the present invention is not limited to the configuration in which the first gypsum slurry 63 is applied to both of the first board base paper 611 and the second board base paper 612. For example, the first gypsum slurry 63 may be applied to either the first board base paper 611 or the second board base paper 612. Further, the first gypsum slurry 63 may be disposed only on the side edges, which are the edges of the first board base paper 611 in the width direction.

The first board base paper 611 is conveyed in the same conveying direction. The conveying direction of the second board base paper 612 is changed by a turning roller 67 toward the conveyance line of the first board base paper 611.

### (2) Supplying Apparatus

The above-described supplying apparatus 20 may supply and apply the liquid material to the application area of the second board base paper 612.

As the liquid material, one or more materials selected from glue, lubricant, and the like may be used as described above. As the above glue, a liquid adhesive may be preferably used. A starch adhesive, a natural rubber latex adhesive, or a synthetic adhesive is more preferable, and an aqueous emulsion adhesive is even more preferable. As used herein, the “liquid material” or the “liquid adhesive” refers to a material that is a liquid at use temperature, for example, at room temperature (27 °C).

A position where the supplying apparatus 20 is installed is not particularly limited, and may be selected depending on the type of the liquid material or the like. However, for example, the supplying apparatus 20 may be installed before a position where the gypsum slurry is supplied to the second board base paper 612.

The arrangement of the supplying apparatus 20 is not limited to the configuration illustrated in FIG. 6. For example, instead of the second board base paper 612, or in addition to the second board base paper 612, the liquid material may be supplied and applied to the first board base paper 611. The gypsum plate manufacturing apparatus 60 may have a plurality of supplying apparatuses 20 as necessary.

The supplying apparatus 20 has already been described, and thus, the description thereof will be omitted. In the case where the supplying apparatus includes the spreading members 28A and 28B, as illustrated in FIG. 2, it is preferable to provide the above-described rollers 29 for supporting the loads and the like of the spreading members 28A and 28B and the second board base paper 612.

### (3) Molding Machine

The first board base paper 611 and the second board base paper 612 being conveyed in the gypsum plate manufacturing apparatus 60 reach the molding machine 68. The second gypsum slurry 64 is supplied between the thin layers of the first gypsum slurry 63 formed on the first board base paper 611 and the second board base paper 612 from the mixer 62 via a pipe line 653. As a result, a continuous stacked body having a layer formed by the first gypsum slurry 63, a layer formed by the second gypsum slurry 64, and a layer formed by the first gypsum slurry 63 can be formed between the first board base paper 611 and the second board base paper 612.

Note that the present invention is not limited to the configuration in which the high-density first gypsum slurry 63 and the low-density second gypsum slurry 64 are used. For example, a gypsum slurry with one specific density may be manufactured and supplied onto the board base paper.

Specifically, for example, a gypsum slurry with a predetermined density is supplied onto the first board base paper 611, which is continuously conveyed, so as to deposit a layer of the gypsum slurry on the first board base paper 611. Then, the application areas that are the edges of the first board base paper 611 in the width direction are folded along predetermined carved lines so as to extend upward and then extend inward. As a result, the deposited layer of the gypsum slurry is partially wrapped by the first board base paper 611. Then, the second board base paper 612, which is conveyed at the same speed, is stacked on the deposited layer of the gypsum slurry partially wrapped by the first board base paper 611. The stacked body then passes through the molding machine 68 for determining the thickness and the width of the gypsum plate, and is molded. The gypsum plate may be molded in this manner. In this case, a layer of the gypsum slurry with the predetermined density is formed between the first board base paper 611 and the second board base paper 612.

As described, the molding machine 68 of the gypsum plate manufacturing apparatus 60 may perform a molding process for molding a gypsum slurry, and can thereby manufacture a gypsum slurry molded body 69.

The gypsum plate manufacturing apparatus according to the present embodiment may further include any members as necessary.

### (4) Dryer and Cutter

In the gypsum plate manufacturing apparatus according to the present embodiment, for example, a dryer, a cutter, or the like may be provided downstream of the molding machine 68, as necessary.

The dryer can reduce excess moisture in the gypsum slurry molding.

One or more cutters may be provided as necessary. For example, a first cutter (rough cutting cutter) that roughly cuts a manufactured gypsum plate in order to place the gypsum plate in the dryer may be provided. Further, a second cutter that cuts the manufactured gypsum plate according to the size of an end product may be provided.

The type of the gypsum plate manufactured by the gypsum plate manufacturing apparatus according to the present embodiment or the method of manufacturing the gypsum plate described later is not particularly limited, and various gypsum plates may be exemplified in which the covering material is provided on the surface of the gypsum hardened body obtained by hardening the gypsum slurry. Examples of the gypsum plate include a gypsum board in which the surface of the gypsum plate is coated with a board base paper, a glass mat gypsum board in which the surface of the gypsum plate is covered with a glass fiber mat (sheet), and the like.

According to the gypsum plate manufacturing apparatus according to the present embodiment, because the supplying apparatus is used, the position of the edge in the width direction of the covering material being conveyed is detected, and even when the position of the edge of the covering material in the width direction changes, the liquid material can be supplied and applied to a desired position. Therefore, the occurrence of problems caused by failure to apply the liquid material to a proper application position, such as the occurrence of gluing failure at the bonding portion of the covering material, for example, can be reduced. As a result, the occurrence of defective gypsum plates that do not meet standards, can be reduced.

### Method of Manufacturing Gypsum Plate

The method of manufacturing the gypsum plate according to the present embodiment may include a liquid material supply process of supplying a liquid material to a covering material by the liquid material supplying apparatus for the gypsum plate described above.

The method of manufacturing the gypsum plate according to the present embodiment may include, for example, the following processes.

A gypsum slurry preparation process of preparing a gypsum slurry by kneading calcined gypsum, water, and, in some cases, various additives, which are raw materials of the gypsum slurry.

A liquid material supply process of supplying a liquid material to a covering material by the liquid material supplying apparatus for the gypsum plate.

A molding process of supplying the gypsum slurry between two covering materials, and molding the gypsum slurry into a plate shape.

A hardening process of hardening the plate-shaped molded body obtained in the molding process.

Each of the processes will be described by taking a case where the gypsum plate to be manufactured is a gypsum board as an example.

### (Gypsum Slurry Preparation Process)

In the gypsum slurry preparation process, a gypsum slurry can be prepared by kneading the above-described calcined gypsum, water, and, in some cases, various additives and foam.

For example, as described with respect to the gypsum plate manufacturing apparatus, the raw material components may be kneaded by the mixer or the like to prepare a gypsum slurry. The raw materials of the gypsum slurry have already been described above, and the description thereof will be omitted.

### (Liquid Material Supply Process)

In the liquid material supply process, the liquid material supplying apparatus for the gypsum plate may supply and apply the liquid material to the application area of the board base paper, for example, the second board base paper, which is the covering material. The liquid material supplying apparatus and the like have already been described above, and the description thereof will be omitted.

### (Molding Process)

In the molding process, the gypsum slurry obtained in the gypsum slurry preparation process is supplied between two board base papers, and is molded into a plate shape.

For example, as described with respect to the gypsum plate manufacturing apparatus, in the gypsum slurry molding process, the high-density first gypsum slurry 63 and the low-density second gypsum slurry 64 are formed in advance. Then, in the molding process, a continuous stacked body having a layer of the first gypsum slurry 63, a layer of the second gypsum slurry 64, and a layer of the first gypsum slurry 63 can be formed in that order between the first board base paper 611 and the second board base paper 612. Then, the stacked body passes through the molding machine 68 for determining the thickness of a gypsum plate, and is molded into a plate shape. As a result, a gypsum slurry molded body can be formed.

However, the present invention is not limited to the above configuration. In the molding process, a gypsum slurry with a desired density may be supplied between the board base papers, and may be molded into a plate shape by the molding machine.

### (Hardening Process)

The hardening process may be performed after the molding process. The hardening process is a process of hardening the gypsum slurry molded body obtained in the molding process.

In the hardening process, acicular crystals of gypsum dihydrate are formed by a hydration reaction, and as a result, calcined gypsum (gypsum hemihydrate) in the gypsum slurry sets and solidifies. Accordingly, in the hardening process, the calcined gypsum and water added to the gypsum slurry react with each other in the molded body formed in the molding process, and the hydration reaction of the calcined gypsum proceeds.

The method of manufacturing the gypsum plate may further include any processes. Specifically, the method may include the following processes, for example.

A first cutting process of cutting the gypsum slurry molded body.

A drying process of drying the cut gypsum slurry molded body.

A second cutting process of cutting a gypsum plate.

### (First Cutting Process)

In the first cutting process, the gypsum slurry molded body may be cut. Note that, after the gypsum slurry molded body is formed in the molding process, the gypsum slurry gradually hardens. Therefore, the first cutting process may be performed, for example, while the hardening process is performed or after the hardening process is completed. The first cutting process is preferably performed after the hardening process proceeds to such an extent that the gypsum slurry molded body can be cut.

The first cutting process may also be referred to as a rough cutting process in which the gypsum slurry molded body is cut into a desired size according to, for example, the size of the dryer or the like used in the drying process described later.

### (Drying Process)

In the drying process, excess water contained in the gypsum slurry molded body may be dried. Note that the drying process may be performed by supplying the gypsum slurry molded body that has been subjected to the hardening process. The drying process may be performed by using the dryer to forcibly dry the molded body.

A method of forcibly drying the molded body by the dryer is not particularly limited. For example, the dryer may be provided on a conveyance path of the molded body, and the molded body may pass through the dryer so as to be continuously dried. Alternatively, the molded body may be introduced into the dryer and the molded body may be dried for each batch.

### (Second Cutting Process)

The second cutting process of cutting the gypsum plate may be included, for example.

The second cutting process may be performed, for example, after the drying process. In the second cutting process, the gypsum plate may be cut into a desired product size.

According to the method of manufacturing the gypsum plate according to the present embodiment, because the above-described supplying apparatus is used in the liquid material supplying process, the position of the edge in the width direction of the covering material being conveyed is detected, and even when the position of the edge of the covering material in the width direction changes, the liquid material can be supplied and applied to a desired position. Therefore, the occurrence of problems caused by the failure to apply the liquid material to a proper application position, such as the occurrence of gluing failure at the bonding portion of the covering material, for example, can be reduced. As a result, the occurrence of defective gypsum plates that do not meet standards, can be reduced.

### Appendix

(1) According to one aspect of the present disclosure, a liquid material supplying apparatus for a gypsum plate for supplying a liquid material to a covering material of a gypsum plate, the liquid material supplying apparatus including:
a tank configured to store the liquid material;
a liquid material supply pipe that is connected to the tank and is configured to supply the liquid material;
a displacement device configured to displace a position of the liquid material supply pipe;
an edge detection device configured to detect a position of an edge of the covering material in a width direction; and
a controller configured to displace, by the displacement device, the position of the liquid material supply pipe according to the position of the edge of the covering material in the width direction detected by the edge detection device.

(2) In (1), the edge detection device may include a first laser sensor and a second laser sensor arranged along the width direction of the covering material, and
when the covering material is positioned at a light projection position of the first laser sensor and the covering material is not positioned at a light projection position of the second laser sensor, the controller may be configured to displace, by the displacement device, the position of the liquid material supply pipe according to the position of the edge of the covering material in the width direction.

(3) In (2), the controller may further include a support to which the liquid material supply pipe and the edge detection device are fixed, wherein
the displacement device may be configured to displace the position of the liquid material supply pipe and a position of the edge detection device by displacing a position of the support along the width direction of the covering material, and
the controller may be configured to displace, by the displacement device, the position of the support such that the covering material is positioned at the light projection position of the first laser sensor and that the covering material is not positioned at the light projection position of the second laser sensor.

(4) In any one of (1) to (3), the liquid material supply pipe is provided for each of both edges of the covering material in the width direction.

(5) In any one of (1) to (4), the edge detection device may be configured to detect a position of one of both edges of the covering material in the width direction, and
the displacement device may be configured to displace a position of the liquid material supply pipe provided for the one of the both edges of the covering material in the width direction.

(6) A gypsum plate manufacturing apparatus according to an aspect of the present disclosure includes the liquid material supplying apparatus for the gypsum plate according to any one of (1) to (5).

(7) A method of manufacturing a gypsum plate according to an aspect of the present disclosure includes a liquid material supply process of supplying the liquid material to the covering material by the liquid material supplying apparatus for the gypsum plate according to any one of (1) to (5).

Although the liquid material supplying apparatus for the gypsum plate, the gypsum plate manufacturing apparatus, and the method of manufacturing the gypsum plate have been described above with reference to the embodiments and the like, the present invention is not limited to the above embodiments and the like. Variations modifications and modifications are possible within the scope of the present invention recited in the claims.

The present international application claims priority to Japanese Patent Application No. 2022-131120, filed Aug. 19, 2022, with the Japanese Patent Office, the contents of which are incorporated herein by reference in their entirety.

### EXPLANATION OF REFERENCE NUMERALS

11, 12, 13 Gypsum board
11A, 12A, 13A Edge
110, 120, 130 Gypsum core
111, 121, 131 First board base paper
112, 122, 132 Second board base paper
111A, 111B Corner
121A, 121B, 121C Corner
131A, 131B, 131C Corner
113, 123, 133 Bonding portion
CX Angle of corner
10 Covering material
10A, 10B Edge
100A, 100B Application area
A Block arrow
B Arrow
20 Supplying apparatus
21A, 21B First liquid material supply pipe
22A, 22B Discharge port
23A, 23B Drive device (displacement device)
24 Linear motion mechanism (displacement device)
25 Edge detection device
251 Fixing base
252A First laser sensor
252B Second laser sensor
253A, 253B L-shaped fitting
254 Shim plate
T Distance
26A, 26B Controller
27A, 27B Support
28A, 28B Spreading member
29 Roller
30A, 30B Pump
31 Tank
32 Main tank
33 Third liquid material supply pipe
34 Second liquid material supply pipe
35 Liquid material
51, 52 Light projection position
60 Gypsum plate manufacturing apparatus
611 First board base paper
612 Second board base paper
62 Mixer
621, 622, 623 Dispensing port
63 First gypsum slurry
64 Second gypsum slurry
651, 652 Delivery pipe
653 Pipe line
66 Roller coater
661 Coating roller
662 Receiving roller
663 Residue removal roller
67 Turning roller
68 Molding machine
69 Gypsum slurry molded body

1. A liquid material supplying apparatus for a gypsum plate for supplying a liquid material to a covering material of a gypsum plate, the liquid material supplying apparatus comprising:
a liquid material supply pipe configured to supply the liquid material;
a displacement device configured to displace a position of the liquid material supply pipe;
an edge detection device configured to detect a position of an edge of the covering material in a width direction; and
a controller configured to displace, by the displacement device, the position of the liquid material supply pipe according to the position of the edge of the covering material in the width direction detected by the edge detection device.

2. The liquid material supplying apparatus for the gypsum plate according to claim 1, wherein
the edge detection device includes a first laser sensor and a second laser sensor arranged along the width direction of the covering material, and
when the covering material is positioned at a light projection position of the first laser sensor and the covering material is not positioned at a light projection position of the second laser sensor, the controller is configured to displace, by the displacement device, the position of the liquid material supply pipe according to the position of the edge of the covering material in the width direction.

3. The liquid material supplying apparatus for the gypsum plate according to claim 2, further comprising a support to which the liquid material supply pipe and the edge detection device are fixed, wherein
the displacement device is configured to displace the position of the liquid material supply pipe and a position of the edge detection device by displacing a position of the support along the width direction of the covering material, and
the controller is configured to displace, by the displacement device, the position of the support such that the covering material is positioned at the light projection position of the first laser sensor and that the covering material is not positioned at the light projection position of the second laser sensor.

4. The liquid material supplying apparatus for the gypsum plate according to claim 1, wherein the liquid material supply pipe is provided for each of both edges of the covering material in the width direction.

5. The liquid material supplying apparatus for the gypsum plate according to claim 1, any wherein
the edge detection device is configured to detect a position of one of both edges of the covering material in the width direction, and
the displacement device is configured to displace a position of the liquid material supply pipe provided for the one of the both edges of the covering material in the width direction.

6. A gypsum plate manufacturing apparatus comprising the liquid material supplying apparatus for the gypsum plate of claim 1.

7. A method of manufacturing a gypsum plate, the method comprising:
a liquid material supply process of supplying, by the liquid material supplying apparatus for the gypsum plate of claim 1, the liquid material to the covering material.

8. The liquid material supplying apparatus for the gypsum plate according to claim 2, wherein the liquid material supply pipe is provided for each of both edges of the covering material in the width direction.

9. The liquid material supplying apparatus for the gypsum plate according to claim 2, wherein
the edge detection device is configured to detect a position of one of both edges of the covering material in the width direction, and
the displacement device is configured to displace a position of the liquid material supply pipe provided for the one of the both edges of the covering material in the width direction.

10. A gypsum plate manufacturing apparatus comprising the liquid material supplying apparatus for the gypsum plate of claim 2.

11. A method of manufacturing a gypsum plate, the method comprising:
a liquid material supply process of supplying, by the liquid material supplying apparatus for the gypsum plate of claim 2, the liquid material to the covering material.

12. The liquid material supplying apparatus for the gypsum plate according to claim 3, wherein the liquid material supply pipe is provided for each of both edges of the covering material in the width direction.

13. The liquid material supplying apparatus for the gypsum plate according to claim 3, wherein
the edge detection device is configured to detect a position of one of both edges of the covering material in the width direction, and
the displacement device is configured to displace a position of the liquid material supply pipe provided for the one of the both edges of the covering material in the width direction.

14. A gypsum plate manufacturing apparatus comprising the liquid material supplying apparatus for the gypsum plate of claim 3.

15. A method of manufacturing a gypsum plate, the method comprising:
a liquid material supply process of supplying, by the liquid material supplying apparatus for the gypsum plate of claim 3, the liquid material to the covering material.
